(19) United States
(12) Patent Application Publication
(10) Pub. No.: US 2017/0145900 A1
(43) Pub. Date: May 25, 2017

(54) Multiple Pre-Chamber Ignition Systems and Methods

(71) Applicant: Caterpillar Inc., Peoria, IL (US)

(72) Inventor: Jaswinder Singh, Dunlap, IL (US)

(73) Assignee: Caterpillar Inc., Peoria, IL (US)

(21) Appl. No.: 14/945,617

(22) Filed: Nov. 19, 2015

(51) Int. Cl. F02B 19/18

(52) U.S. Cl. CPC F02B 19/18

(57) ABSTRACT

The disclosure describes multipoint injection systems for an engine and methods of operation of the same. The systems and methods can include an engine, including an engine block having at least one cylinder bore, a piston having a piston crown facing a flame deck surface such that a combustion main chamber is defined within a cylinder bore and located between the piston crown and the flame deck surface, the piston crown further including a piston bowl having a generally concave shape, and a combustion pre-chamber having a nozzle tip disposed in fluid communication with the combustion main chamber, the nozzle tip having at least one nozzle opening configured to inject a fuel jet into the combustion main chamber, wherein the piston includes a piston wall located around a circumference of the piston bowl, the piston wall including at least one cavity.

### TECHNICAL FIELD

This disclosure relates generally to internal combustion engines and, more particularly, to natural gas engines.

### BACKGROUND

Internal combustion engines are well known. Those employing gasoline as fuel typically employ a number of cylinders which compress a gasoline and air mixture such that upon firing of a spark plug associated with each cylinder, the compressed mixture ignites. The expanding combustion gases resulting from the ignition move a piston within the cylinder. Upon reaching an end of its travel in one direction within the cylinder, the piston reverses direction to compress another volume of the gasoline and air mixture. The resulting mechanical energy of the moving piston can and has been harnessed for use in myriad applications, foremost among which is the propulsion of vehicles.

Another type of internal combustion engines uses natural gas as the fuel source. For example, it is known to provide a compressed natural gas engine wherein a piston reciprocates within a cylinder. A spark plug is positioned within a cylinder head associated with each cylinder and each respective spark plug is controlled by a timing circuit such that upon the piston reaching the end of its compression stroke, the spark plug fires to thereby ignite the compressed mixture.

In still further types of internal combustion engines, pre-chambers are employed in conjunction with natural gas engines. A pre-chamber is associated with each cylinder of the natural gas engine and is provided with a spark plug to initiate combustion within the pre-chamber which can then be communicated to the main combustion chamber.

In some engines, multiple pre-chambers can be used to enhance combustion. One example of such a combustion system is disclosed in U.S. Pat. No. 6,095,112 to Glauber et al. The system in U.S. Pat. No. 6,095,112 includes a reciprocating piston engine which is selectively operable in either a gas operation mode with a gaseous fuel or a diesel operation mode with a liquid fuel and includes a main combustion chamber which has an inlet for receiving gas and/or air, an injection device and an outlet. At least one precombustion chamber is connected to the main combustion chamber by at least one precombustion chamber output that opens into said main combustion chamber. Each precombustion chamber has an applied-ignition device for igniting the contents of the precombustion chamber during gas operation. An optimization of exhaust gas values, particularly of concentrations of nitrogen oxides (NOx), is attained by the applied-ignition device and a separate gas line for supplying the precombustion chamber with gas, thereby allowing a leaner fuel mixture to be used in the main combustion chamber. The use of multiple precombustion chambers permits the individual activation of an ignition point in each precombustion chamber.

The improvement of the design of any particular engine is often desirable, in the form of increased engine efficiency and/or reduced emissions, especially in light of increasing fuel costs and ever more strict regulations on engine emissions. Accordingly, there is a need for improved engine systems.

### SUMMARY

In one aspect, the disclosure describes a multiple pre-chamber injection system for an engine. The system can include an engine, including an engine block having at least one cylinder bore, a cylinder head having a flame deck surface disposed at one end of the cylinder bore, a piston configured to reciprocate within the cylinder bore, the piston having a piston crown facing the flame deck surface such that a combustion main chamber is defined within the cylinder bore and located between the piston crown and the flame deck surface, a combustion pre-chamber disposed above the combustion main chamber, and a plurality of combustion auxiliary pre-chambers in fluid communication with the combustion pre-chamber.

In another aspect, the disclosure describes a cylinder head including a flame deck surface disposed at one end of a cylinder bore, a combustion pre-chamber disposed at least partially in the cylinder head, and a plurality of combustion auxiliary pre-chambers disposed at least partially in the cylinder head, wherein the plurality of combustion auxiliary pre-chambers are in fluid communication with the combustion pre-chamber.

In yet another aspect, the disclosure describes a method for operating a combustion system, comprising the steps of reciprocating a piston within a cylinder bore of an engine, the piston having a piston crown facing a flame deck surface of a cylinder head such that a combustion main chamber is defined within the cylinder bore and located between the piston crown and the flame deck surface, the piston crown including a piston bowl having a generally concave shape, igniting an air and fuel mixture in a combustion pre-chamber such that a fuel jet travels from the combustion pre-chamber through a conduit to at least one combustion auxiliary pre-chamber, and injecting the fuel jet from at least one nozzle opening in a nozzle tip of the at least one combustion auxiliary pre-chamber into the combustion main chamber.

Further and alternative aspects and features of the disclosed principles will be appreciated from the following detailed description and the accompanying drawings. As will be appreciated, the gaseous fuel systems, multiple pre-chamber ignition systems, and methods disclosed herein are capable of being carried out in other and different aspects, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 illustrates a cross section of an engine combustion chamber in accordance with an aspect of the disclosure.

FIG. 2 illustrates a top view of a pre-chamber assembly in an engine block in accordance with another aspect of the disclosure.

FIG. 3 illustrates a bottom view of a pre-chamber assembly in an engine block in accordance with another aspect of the disclosure.

FIG. 4 is a flow chart illustrating steps of a method for operating a combustion system according to principles of the present disclosure.

FIG. 5 is a schematic drawing representing a system for generating a three-dimensional model of a cylinder head.

### DETAILED DESCRIPTION

The present disclosure can be understood more readily by reference to the following detailed description of the disclosure and the examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

Each of the materials disclosed herein are either commercially available and/or the methods for the production thereof are known to those of skill in the art. It is understood that the compositions disclosed herein have certain functions. Disclosed herein are certain structural parameters for performing the disclosed functions and it is understood that there are a variety of structures that can perform the same function that are related to the disclosed structures, and that these structures will typically achieve the same result.

Natural gas engines such as large bore lean burn engines can have unstable combustion issues such as a misfire when the fuel is burned with an excess of air or when the brake mean effective pressure (BMEP) is increased. More complete ignition of the fuel in the combustion chamber may be desired in order to improve combustion stability, speed, efficiency, and reduce emissions.

An exemplary aspect of the disclosure provides a multiple pre-chamber ignition system that may enhance the combustion by taking plumes or torches coming out of a single main pre-chamber and sending them to multiple distributed pre-chambers located around and away from the main pre-chamber and away from the center main pre-chamber. These multiple distributed pre-chambers located around and away from the main pre-chamber. These distributed pre-chambers can then start multiple new combustion plumes in various directions to provide a more complete combustion. Such a combustion system can improve the speed, stability, and efficiency of the combustion while reducing unburned hydrocarbon (UHC) and nitrogen oxides (NOx).

Now referring to the drawings, wherein like reference numbers refer to like elements, there are illustrated systems and methods for operating a combustion system. Any numerical values recited herein are by way of illustration only. In other aspects, other values may be used, and the values can be varied in any fashion as appropriate to the application.

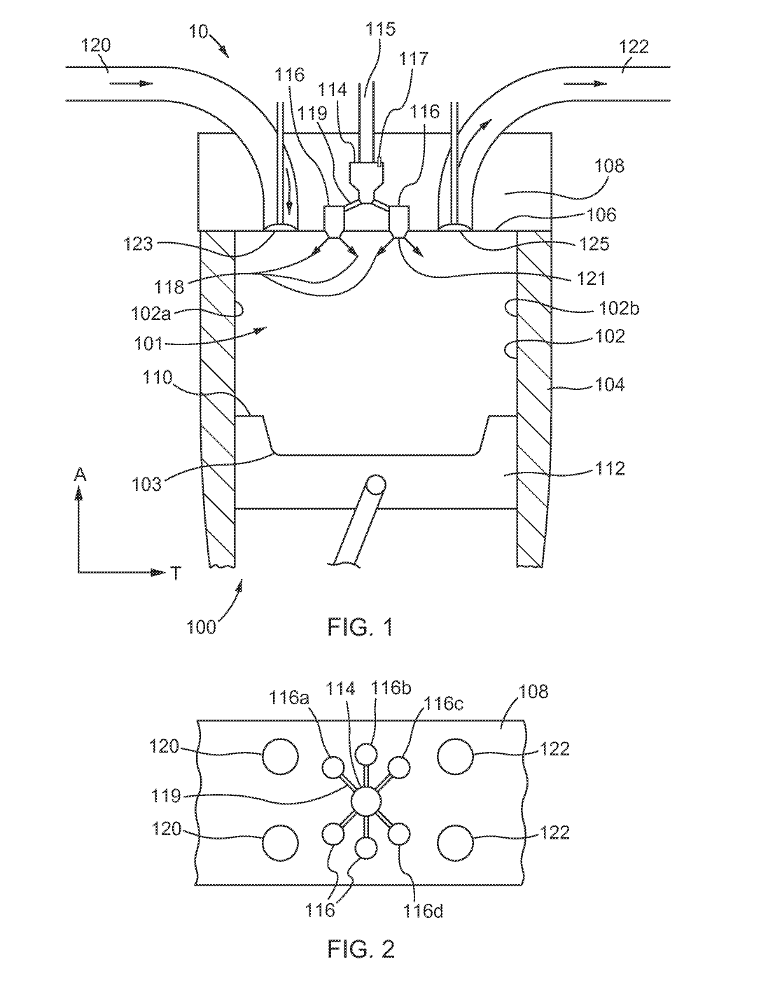

FIG. 1 illustrates a cross section of an engine combustion chamber in accordance with an aspect of the disclosure. As seen in FIG. 1, a combustion system 100 of an engine 10 can include an engine block 104 with at least one cylinder bore 102. The combustion system 100 may be also referred to as a multiple pre-chamber ignition system. In an aspect, the combustion main chamber 101 of the combustion system 100 can have a generally cylindrical shape that is defined within a cylinder bore 102 formed within a crankcase or engine block 104. A cylinder head 108 may include a flame deck surface 106 disposed at one end of the cylinder bore 102. A piston 112 can be configured to reciprocate within the cylinder bore 102, where the piston 112 can have a piston crown 110 facing the flame deck surface 106 such that a combustion main chamber 101 is defined within the cylinder bore 102 between the piston crown 110 and the flame deck surface 106. The piston crown 110 may further include a piston bowl 103. In an aspect, the piston bowl 103 may have a generally concave shape. In an aspect, the combustion main chamber 101 can be further defined at one end by a flame deck surface 106 of a cylinder head 108, and at another end by a piston crown 110 of a piston 112 that is reciprocally disposed within the bore 102. The pre-chamber 114 can be in fluid communication with a fuel line 115 and can be mounted in the cylinder head 108. In certain aspects, the combustion pre-chamber 114 can be located in the cylinder head 108 opposite the combustion main chamber 101 in an axial direction A, where the axial direction A is parallel to the direction of movement of the piston 112 within the cylinder bore 102. A number of combustion auxiliary pre-chambers 116 can be in fluid communication with the combustion pre-chamber 114.

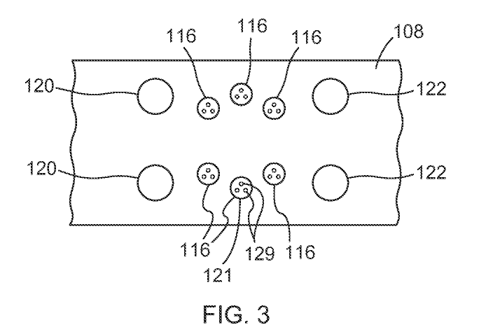

The combustion pre-chamber 114 can be in fluid communication with a fuel line 115 to provide fuel to the combustion pre-chamber 114. Fuel and air can enter the combustion main chamber 101 through the intake 120 when the intake valve 123 is opened. The fuel and air can then enter the combustion pre-chamber 114 through the nozzle openings 129 (FIG. 3) and mix with the fuel in the combustion pre-chamber 114. In some aspects, a spark plug 117 can be disposed in the combustion pre-chamber 114, where the spark plug 117 can be configured to ignite the fuel and air mixture in the combustion pre-chamber 114.

The combustion auxiliary pre-chambers 116 may be in fluid communication with the combustion pre-chamber 114 through at least one conduit 119. In some aspects, at least a portion of at least one of the plurality of combustion auxiliary pre-chambers 116 can be located below the combustion pre-chamber 114 in the axial direction towards the flame deck surface 106. In certain aspects, the combustion auxiliary pre-chambers 116 can be located around the combustion pre-chamber 114, with at least a portion of the combustion auxiliary pre-chambers 116 located in the cylinder head 108 and at least a portion of the combustion auxiliary pre-chambers 116 located in the combustion main chamber 101. In some aspects, as seen for example in FIG. 1, the combustion pre-chamber 114 is disposed above the flame deck surface 106 such that the combustion pre-chamber 114 does not enter the combustion main chamber 101. In an aspect, the combustion pre-chamber 114 can be disposed within the cylinder head 108 such that an entirety of the combustion pre-chamber 114 is positioned outside the combustion main chamber 101.

The nozzle openings 129 can be configured to send fuel jets 118 in a substantially transverse direction towards a side wall 102a, 102b of the cylinder bore 102. In some aspects, the nozzle openings 129 can be configured to send a first fuel jet 118 towards a first side wall 102a of the cylinder bore 102, and a second fuel jet 118 to a side 102b of the cylinder bore 102 than the first fuel jet 118, where the first side 102a is located opposite to the second side 102b in the cylinder bore 102.

During operation of the engine 10, air can be admitted into the combustion main chamber 101 via an intake 120 when one or more intake valves 123 are open during an intake stroke. The inlet passage 120 can provide a fuel and air mixture to the combustion main chamber 101. A fuel and air mixture in the combustion pre-chamber 114 can be ignited by a spark plug 117 or other ignition device in the pre-chamber 114. When ignited, fuel is sprayed through conduits 119 into the combustion auxiliary pre-chambers 116, and then through nozzle openings 129 in the nozzle tips 121 of the combustion auxiliary pre-chambers 116. Each nozzle opening 129 can create a fuel jet 118 that generally disperses, igniting the fuel and air mixture in the combustion main chamber 101. This can provide for a more complete combustion in the combustion main chamber 101 than if combustion auxiliary pre-chambers 116 were not included, as more fuel jets 118 are included and extend in multiple directions in the combustion main chamber 101. Following combustion, exhaust gas can be expelled from the combustion chamber through an exhaust conduit 122 when one or more exhaust valves 125 is/are open during an exhaust stroke.

Referring now to FIGS. 2-3, in certain aspects, the combustion auxiliary pre-chambers 116 may be located equidistant from an centerline extending in an axial direction A of the combustion pre-chamber 114 in a radial or transverse direction T outward from the combustion pre-chamber 114 and towards the engine block 104 (FIG. 1). For example, as seen in FIG. 1, the two combustion auxiliary pre-chambers 116 are shown equally spaced apart from the combustion pre-chamber 114 in the transverse direction T. In other aspects, the combustion auxiliary pre-chambers 116 may be located at different distances from the combustion pre-chamber 114. In further aspects, the combustion auxiliary pre-chambers 116 can be equally spaced apart from each other around the combustion pre-chamber 114, while in other aspects the combustion auxiliary pre-chambers 116 may be spaced apart at different distances from each other. For example, as seen in FIG. 2, combustion auxiliary pre-chambers 116a, 116b, and 116c are spaced apart an equal distance from each other, while combustion auxiliary pre-chamber 116d is spaced apart a greater distance from combustion auxiliary pre-chamber 116c, than combustion auxiliary pre-chamber 116c is from combustion auxiliary pre-chamber 116b. In another aspect, a distance between adjacent ones of the plurality of combustion auxiliary pre-chambers 116 can be equal from each other around the combustion pre-chamber 114.

The combustion auxiliary pre-chambers 116 can each include a nozzle tip 121 disposed in fluid communication with the combustion main chamber 101, as seen in FIG. 1. The nozzle tip 121 can include at least one nozzle opening 129 configured to inject a fuel jet 118 (FIG. 1) into the combustion main chamber 101 (FIG. 1). A nozzle tip 121 can include any number of nozzle openings 129. In some aspects, a nozzle tip 121 can include two nozzle openings 129, while in other aspects a nozzle tip 121 can include three nozzle openings 129 (FIG. 3). The combustion system 100 can include any number of combustion auxiliary pre-chambers 116. In certain aspects, the combustion system 100 (FIG. 1) can include six combustion auxiliary pre-chambers 116. In an aspect where a nozzle tip 121 includes multiple nozzle openings 129, the nozzle openings 129 can be located equidistant from a centerline of one of the plurality of combustion auxiliary pre-chambers 116 in a radial or transverse direction T, where the centerline extends in the axial direction A.

The nozzle openings 129 can extend in any direction to direct fuel jets 118 (FIG. 1) from the combustion auxiliary pre-chambers 116 into the combustion main chamber 101 (FIG. 1). In the aspect shown in FIG. 1, the conduits 119 are straight between the combustion pre-chamber 114 and the combustion auxiliary pre-chambers 116. In another aspect, the conduits 119 may be curved between the combustion pre-chamber 114 and the combustion auxiliary pre-chambers 116. In certain aspects, a cross-sectional dimension, for example a diameter of the conduits 119 may be uniform between the combustion pre-chamber 114 and the combustion auxiliary pre-chambers 116. In some aspects, conduits 119 may have a variable diameter, such that the diameter of the conduits 119 closer to the combustion pre-chamber 114 may be different from the diameter of the conduits 119 closer to the combustion auxiliary pre-chambers 116. For example, in one aspect the diameter of the conduits 119 closer to the combustion pre-chamber 114 may be greater than the diameter of the conduits 119 closer to the combustion auxiliary pre-chambers 116.

In certain aspects, the diameter of the combustion pre-chamber 114 may be uniform along the combustion pre-chamber 114 extending in the axial direction A. In other aspects, the combustion pre-chamber 114 may have a variable diameter, such that the diameter of the combustion pre-chamber 114 closer to the flame deck surface 106 may be different from the diameter of the combustion pre-chamber 114 closer to the combustion auxiliary pre-chambers 116. For example, in one aspect the diameter of the conduits 119 closer to the combustion pre-chamber 114 may be greater than the diameter of the conduits 119 closer to the combustion auxiliary pre-chambers 116.

### INDUSTRIAL APPLICABILITY

Aspects of a combustion system for an engine using a gaseous fuel and a method for operating a combustion system are described herein. The industrial applicability of aspects constructed according to principles of the present disclosure will be readily appreciated from the foregoing discussion. The described principles are applicable for use in multiple aspects of an engine and have applicability in many machines which include an engine.

The disclosed systems and method of operating a combustion system may be applicable to any application of an engine containing cylinders. The system and method of operating a combustion system of this disclosure may be used in a stand-alone engine, for example, or in an engine that may be coupled to a machine (not shown). In some aspects, the machine can be an “over-the-road” vehicle such as a truck or may be any other type of machine that performs some type of operation associated with an industry such as mining, construction, farming, transportation, or any other industry known in the art. For example, the machine may be an off-highway truck, earth-moving machine, such as a dump truck, excavator, front loader, or the like.

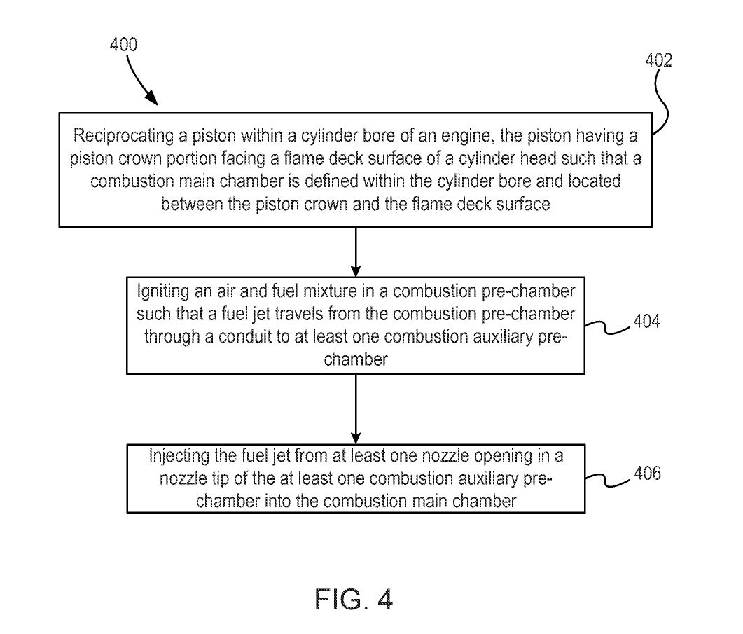

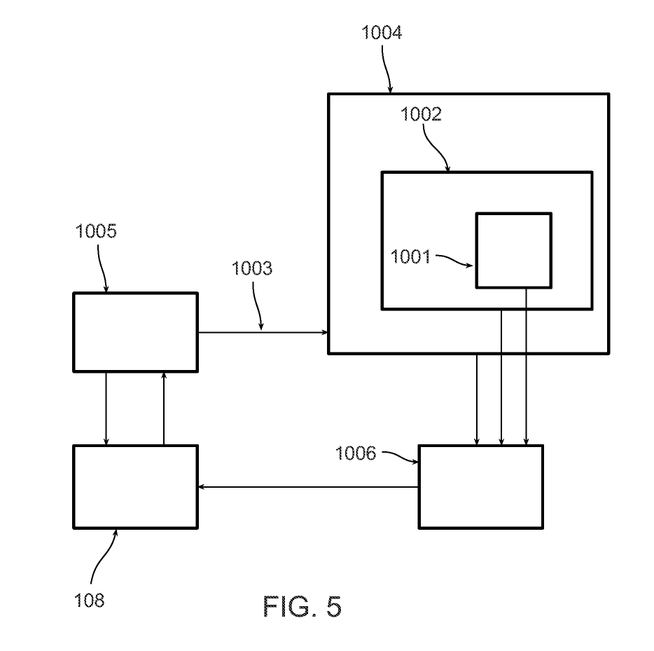

FIG. 4 is a flow chart illustrating steps of a method for operating a combustion system according to principles of the present disclosure. In certain aspects, the method 400 shown in FIG. 4 for operating a combustion system can include the step 402 of reciprocating or moving a piston 112 within a cylinder bore 102 of an engine 10. The piston 112 can include a piston crown 110 facing a flame deck surface 106 of a cylinder head 108 such that a combustion main chamber 101 can be defined within the cylinder bore 102 and between the piston crown 110 and the flame deck surface 106. The piston crown 110 can further include a piston bowl 103 having a generally concave shape. In step 404, an air and fuel mixture in a combustion pre-chamber 114 can be ignited such that a fuel jet 118 travels from the combustion pre-chamber 114 through a conduit 119 to at least one combustion auxiliary pre-chamber 116. The fuel jet 118 can be injected from at least one nozzle opening 129 in a nozzle tip 121 of the at least one combustion auxiliary pre-chamber 116 into the combustion main chamber 101. The method 400 can further include where at least two of the plurality of combustion auxiliary pre-chambers 116 are located equidistant from a centerline of the combustion pre-chamber 114 in a radial direction, and wherein a portion of at least one of the plurality of combustion auxiliary pre-chambers 116 is disposed below the combustion pre-chamber 114 in an axial direction towards the flame deck surface 106.

The disclosed cylinder head 108 may be manufactured using conventional techniques such as, for example, casting or molding. Alternatively, the disclosed cylinder head 108 may be manufactured using conventional techniques generally referred to as additive manufacturing or additive fabrication. Known additive manufacturing/fabrication processes include techniques such as, for example, 3D printing. 3D printing is a process wherein material may be deposited in successive layers under the control of a computer. The computer controls additive fabrication equipment to deposit the successive layers according to a three-dimensional model (e.g. a digital file such as an AMF or STL file) that is configured to be converted into a plurality of slices, for example substantially two-dimensional slices, that each define a cross-sectional layer of the cylinder head 108 in order to manufacture, or fabricate, the cylinder head 108. In one case, the disclosed cylinder head 108 would be an original component and the 3D printing process would be utilized to manufacture the cylinder head 108. In other cases, the 3D process could be used to replicate an existing cylinder head 108 and the replicated cylinder head 108 could be sold as aftermarket parts. These replicated aftermarket cylinder head 108 could be either exact copies of the original cylinder head 108 or pseudo copies differing in only non-critical aspects.

With reference to FIG. 5, the three-dimensional model 1001 used to represent an original cylinder head 108 may be on a computer-readable storage medium 1002 such as, for example, magnetic storage including floppy disk, hard disk, or magnetic tape; semiconductor storage such as solid state disk (SSD) or flash memory; optical disc storage; magneto-optical disc storage; or any other type of physical memory on which information or data readable by at least one processor may be stored. This storage medium may be used in connection with commercially available 3D printers 1006 to manufacture, or fabricate, the cylinder head 108. Alternatively, the three-dimensional model may be transmitted electronically to the 3D printer 1006 in a streaming fashion without being permanently stored at the location of the 3D printer 1006. In either case, the three-dimensional model constitutes a digital representation of the cylinder head 108 suitable for use in manufacturing the cylinder head 108.

The three-dimensional model may be formed in a number of known ways. In general, the three-dimensional model is created by inputting data 1003 representing the cylinder head 108 to a computer or a processor 1004 such as a cloud-based software operating system. The data may then be used as a three-dimensional model representing the physical cylinder head 108. The three-dimensional model is intended to be suitable for the purposes of manufacturing the cylinder head 108. In an exemplary embodiment, the three-dimensional model is suitable for the purpose of manufacturing the cylinder head 108 by an additive manufacturing technique.

In one embodiment depicted in FIG. 5, the inputting of data may be achieved with a 3D scanner 1005. The method may involve contacting the cylinder head 108 via a contacting and data receiving device and receiving data from the contacting in order to generate the three-dimensional model. For example, 3D scanner 1005 may be a contact-type scanner. The scanned data may be imported into a 3D modeling software program to prepare a digital data set. In one embodiment, the contacting may occur via direct physical contact using a coordinate measuring machine that measures the physical structure of the cylinder head 108 by contacting a probe with the surfaces of the cylinder head 108 in order to generate a three-dimensional model. In other embodiments, the 3D scanner 1005 may be a non-contact type scanner and the method may include directing projected energy (e.g. light or ultrasonic) onto the cylinder head 108 to be replicated and receiving the reflected energy. From this reflected energy, a computer would generate a computer-readable three-dimensional model for use in manufacturing the cylinder head 108. In various embodiments, multiple 2D images can be used to create a three-dimensional model. For example, 2D slices of a 3D object can be combined to create the three-dimensional model. In lieu of a 3D scanner, the inputting of data may be done using computer-aided design (CAD) software. In this case, the three-dimensional model may be formed by generating a virtual 3D model of the disclosed cylinder head 108 using the CAD software. A three-dimensional model would be generated from the CAD virtual 3D model in order to manufacture the cylinder head 108.

The additive manufacturing process utilized to create the disclosed cylinder head 108 may involve materials such as plastic, rubber, metal, etc. In some embodiments, additional processes may be performed to create a finished product. Such additional processes may include, for example, one or more of cleaning, hardening, heat treatment, material removal, and polishing. Other processes necessary to complete a finished product may be performed in addition to or in lieu of these identified processes. It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more examples thereof) may be used in combination with each other. Other examples can be used, such as by one of ordinary skill in the art upon reviewing the above description. The Abstract is provided to comply with 37C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description as aspects or examples, with each claim standing on its own as a separate example, and it is contemplated that such examples can be combined with each other in various combinations or permutations. The scope of the invention should be determined with reference to the appended claims, along with the full scope of equivalents to which such claims are entitled.

We claim:

1. An engine, comprising:
an engine block having at least one cylinder bore;
a cylinder head having a flame deck surface disposed at one end of the cylinder bore;
a piston configured to reciprocate within the cylinder bore, the piston having a piston crown facing the flame deck surface such that a combustion main chamber is defined within the cylinder bore and located between the piston crown and the flame deck surface;
a combustion pre-chamber disposed in the cylinder head opposite the piston; and
a plurality of combustion auxiliary pre-chambers in fluid communication with the combustion pre-chamber.

2. The engine of claim 1, wherein at least two of the plurality of combustion auxiliary pre-chambers are located equidistant from the combustion pre-chamber.

3. The engine of claim 1, wherein a distance between adjacent ones of the plurality of combustion auxiliary pre-chambers is equal from each other around the combustion pre-chamber.

4. The engine of claim 1, wherein the combustion pre-chamber is disposed within the cylinder head such that an entirety of the combustion pre-chamber is positioned outside the combustion main chamber.

5. The engine of claim 1, wherein each of the plurality of combustion auxiliary pre-chambers include a nozzle tip disposed in fluid communication with the combustion main chamber.

6. The engine of claim 5, wherein the nozzle tip includes at least one nozzle opening configured to inject a fuel jet into the combustion main chamber.

7. The engine of claim 5, wherein the plurality of combustion auxiliary pre-chambers comprise six combustion auxiliary pre-chambers.

8. The engine of claim 5, wherein the nozzle tip comprises at least three nozzle openings,
wherein a distance between adjacent ones of the at least three nozzle openings is equal from each other in at least one of the plurality of combustion auxiliary pre-chambers.

9. The engine of claim 1, wherein the combustion pre-chamber is in fluid communication with a fuel line, a spark plug is disposed in the combustion pre-chamber, and wherein the piston crown further includes a piston bowl having a generally concave shape.

10. The engine of claim 6, wherein one of the at least one nozzle openings is configured to send a first fuel jet in a direction of a wall of the cylinder bore, and
wherein another of the at least one nozzle openings is configured to send a second fuel jet to an opposite side of the cylinder bore than the first fuel jet.

11. The engine of claim 1, wherein the plurality of combustion auxiliary pre-chambers are in fluid communication with the combustion pre-chamber through at least one conduit, and wherein a portion of at least one of the plurality of combustion auxiliary pre-chambers is disposed between the combustion pre-chamber and the flame deck surface.

12. A cylinder head, comprising:
a flame deck surface disposed at one end of a cylinder bore;
a combustion pre-chamber disposed at least partially in the cylinder head; and
a plurality of combustion auxiliary pre-chambers disposed at least partially in the cylinder head, wherein the plurality of combustion auxiliary pre-chambers are in fluid communication with the combustion pre-chamber.

13. The combustion system of claim 12, wherein at least two of the plurality of combustion auxiliary pre-chambers are located equidistant from a centerline of the combustion pre-chamber in a radial direction, each of the plurality of combustion auxiliary pre-chambers including a nozzle tip.

14. The combustion system of claim 12, wherein the plurality of combustion auxiliary pre-chambers are in fluid communication with the combustion pre-chamber through at least one conduit, and wherein a portion of at least one of the plurality of combustion auxiliary pre-chambers is disposed below the combustion pre-chamber in a direction of the flame deck surface.

15. A method of creating a computer-readable three-dimensional model suitable for use in manufacturing the cylinder head of claim 12, the method comprising:
inputting data representing the cylinder head to a computer; and
using the data to represent the cylinder head as a three-dimensional model, the three dimensional model being suitable for use in manufacturing the cylinder head.

16. The method of claim 15, wherein the inputting of data includes one or more of using a contact-type 3D scanner to contact the cylinder head, using a non-contact 3D scanner to project energy onto the cylinder head and receive reflected energy, and generating a virtual three-dimensional model of the cylinder head using computer-aided design (CAD) software.

17. A computer-readable storage medium having data stored thereon representing a three-dimensional model suitable for use in manufacturing the cylinder head of claim 15.

18. A method for manufacturing the cylinder head of claim 15, the method comprising the steps of:
providing a computer-readable three-dimensional model of the cylinder head, the three-dimensional model being configured to be converted into a plurality of slices that each define a cross-sectional layer of the cylinder head; and
successively forming each layer of the cylinder head by additive manufacturing.

19. A method for operating a combustion system, the method comprising the steps of:
reciprocating a piston within a cylinder bore of an engine, the piston having a piston crown facing a flame deck surface of a cylinder head such that a combustion main chamber is defined within the cylinder bore and located between the piston crown and the flame deck surface, the piston crown including a piston bowl having a generally concave shape;
igniting an air and fuel mixture in a combustion pre-chamber such that a fuel jet travels from the combustion pre-chamber through a conduit to at least one combustion auxiliary pre-chamber; and
injecting the fuel jet from at least one nozzle opening in a nozzle tip of the at least one combustion auxiliary pre-chamber into the combustion main chamber.

20. The method of claim 19, wherein a distance between adjacent ones of a plurality of combustion auxiliary pre-chambers is equal from each other around the combustion pre-chamber, and wherein the combustion pre-chamber is disposed within the cylinder head such that an entirety of the combustion pre-chamber is positioned outside the combustion main chamber.
